(19) United States
(12) Patent Application Publication
(10) Pub. No.: US 2004/0078514 A1
(43) Pub. Date: Apr. 22, 2004

(54) Apparatus and method for simply launching computer process to perform task

(75) Inventors: Gary Kung, (US); Tom Learmonth, (US)

Correspondence Address: JOHN G. CHUPA, LAW OFFICES OF JOHN CHUPA & ASSOCIATES, PC, 28535 ORCHARD LAKE ROAD, SUITE 50, FARMINGTON HILLS, MI, 48334, US

(73) Assignee: I/O INTERCONNECT, INC.

(21) Appl. No.: 10/273,722

(22) Filed: Oct. 18, 2002

(51) Int. Cl. G06F 12/00

(52) U.S. Cl. 711/105

(57) ABSTRACT

Apparatus and methods for consumer friendly, automatically configuring, computer resource enabling, under the control of a flash card reader. Computer processes can be triggered simply by the consumer pressing a button or the occurrence of some physical real-world action. The computer processes are either inherent and fixed in the memory card reader device or they are configured when the reader is connected to a computer for the first time and it discovers the available resources. The inventive way in which the reader launches computer processes, which perform functions such as data archival, editing, printing, send by email, post to web, purchasing of services, encryption, decryption are launched, by a reader device, results in a much simplified consumer interface.

### FIELD OF THE INVENTION

The invention relates to apparatus and methods for simply instigating computer processes to perform tasks such as: data archival, editing, printing, send by email, post to web, purchasing of services, encryption and decryption.

### BACKGROUND OF THE INVENTION

Flash memory cards are used most often when mobile storage of information is required. Their small convenient size allows them to be inserted into small portable electronic devices.

Information may be loaded onto the card, such as when the card is used to store MP3 files in an audio player; or the card may be used to collect information such as photographic images for later print output.

Generally a consumer would store MP3 music files on a computer hard disk drive, and only copy selected files to a flash memory card. Preferably the MP3 files on the computer should be managed in such a way that it is easy to find specific files and for them to be easily selected and downloaded to the flash card.

Generally a consumer would archive photographic images captured by a camera onto a computer hard drive (or burning to CD ROM or DVD). Preferably the photographic images should be stored in a managed way, allowing easy printing, recall, or other manipulation.

A flash memory card reader allows the consumer to both read and write information to memory cards; either as file transfers under Windows (drag and drop for example), or through the execution of an “Open” or “Save as” command in some application software.

In the flash card arena several types of card have been created, but they are all based upon flash rewrite-able memory components. Electrical contacts placed either at one end or on one side of the card make electrical contact with reader contacts to facilitate exchange of electrical signals, comprising data and control lines. Many flash card types use serial data transmission and reception, while types such as Compact Flash use a parallel bus.

A micro-controller within a reader interfaces with the flash card, and responds to commands from the host computer, to perform defined data related functions. Commands and data are sent via a USB connection between the reader and host computer.

### SUMMARY OF THE INVENTION

The invention comprises an apparatus and method, particularly for flash memory card readers, to automate routine processes launched at the command of the consumer. The processes can be inherent and fixed or configurable, but are always launched by simple means of button pressing or card insertion.

For consumer task initiation the flash memory card reader requires the addition of button(s), firmware and device driver, while an automatically initiated task (upon media insertion) just requires a device driver that launches the application upon media detection.

### BRIEF DESCRIPTION OF THE DRAWINGS

The present invention can be more fully understood by reference of the following description and accompanying drawings, in which:

FIG. 1 shows the block diagram of a typical flash memory card reader;

FIG. 2 shows the hardware blocks and software programs of a host computer and the card reader;

FIG. 3 illustrates how specific choices can be presented to the consumer, for easy push button selection; and

FIG. 4 shows a simple reader which can trigger printing of images.

### DETAILED DESCRIPTION OF THE PREFERRED EMBODIMENTS

The following detailed description illustrates the invention by way of example, not by way of limitation of the principles of the invention. This description will clearly enable one skilled in the art to make and use the invention, and describes several embodiments, adaptations, variations, alternatives, and uses of the invention. The description includes what are presently believed to be the best modes of carrying out the invention.

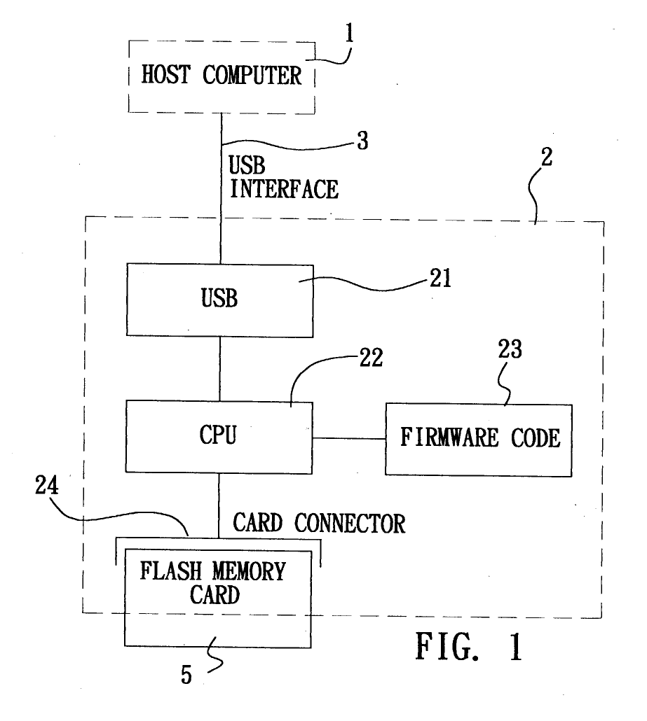

Referring to FIG. 1, which shows the block diagram of a typical flash memory card reader. A flash memory card reader 2 comprises a micro-controller chip 22 (normally based upon an industry standard 8051), one or more memory card connector(s) 24, and a USB interface 21. The function blocks forming a reader 2 are shown, a USB section 21 which handles electrical and protocol for transfers on the USB bus 3, the central processor 22 which executes the firmware 23 for the reader 2 and one or more connectors 24 for flash card media 5 to be inserted into.

Firmware 23, either within a small OTP or Flash chip or within the micro-controller chip 22 itself, controls the functioning of the micro-controller 22. The flash memory card reader 2 must know the file structure and data/control interface for each type of flash card 5 supported. Current types of card 5 include Compact Flash, IBM MicroDrive, Smart Media, Memory Stick, Multi Media Card, and Secure Digital. Some cards can work in the same type of connector, and some have unique connectors.

The reader 2 must also communicate using a USB connection 3 to the computer 1. The Universal Serial Bus 3 is a high speed plug-and-play bus that allows users to have 127 devices connected to a single USB port. While low-speed USB works at 1.5 Mbps, Full-speed works at 12 Mbps and under the naming USB 2.0 the speed is 480 Mbps.

Generally memory card readers are “Mass Storage Compliant” in USB terminology—they are recognized by a USB equipped computer as a removable media drive and work within the Windows OS just like a HDD; in fact the flash card 5 is allocated a drive letter for identification. Users can navigate to files on flash memory cards 5, drag and drop and copy files in the usual fashion—however this is an onerous task for the user to undertake on a repetitive basis. There may also be little consistency in the way the tasks are completed each time. For example in storing away photographic images they may be distributed over several unrelated directories and sub-directories, making their retrieval later very time consuming.

An example in handling multiple MP3 files could be that the user has stored on a computer HDD 13 a collection of music, and wished to copy selected music file to a flash memory card 5 for later playing on a portable MP3 player device. Selecting multiple files and copying to the flash card 5 would be time consuming; however if the MP3 files were organized into ‘play lists’, they could be copied as a group.

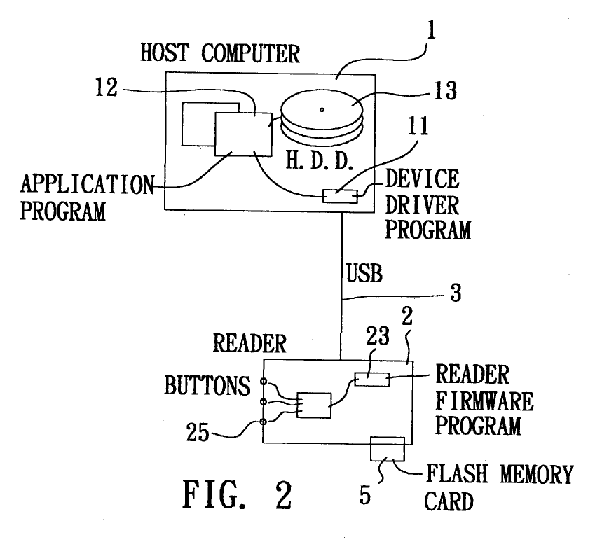

Referring to FIG. 2, which shows the hardware blocks and software programs of a host computer and the card reader. The host computer 1 comprising, amongst other things, a device driver 11 to handle the transfers with the reader 2, at least one application program 12, and a data storage device 13.

The micro-controller 22 of the reader 2 has the ability to detect the insertion of flash memory card(s) 5. To allow the consumer to initiate tasks one or more electrical push buttons 25 can be added, the status of these button(s) 25 can be sensed by inputs on the micro-controller chip 22.

A device driver program 11 continually checks with the reader 2 for any button 25 actuation. The device driver 11 is typically written in lower level code, such as C++, and quickly checks a couple of times per second for any button 25 actuation. Alternatively the USB HID (Human Interface Device) facility could be used if the reader 2 was made a composite USB device.

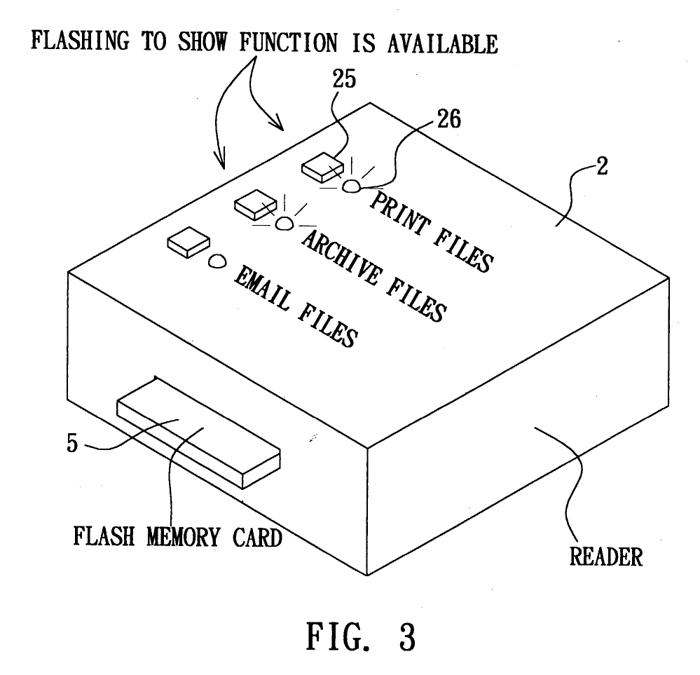

Referring to FIG. 3, which illustrates how specific choices can be presented to the consumer, for easy push button selection. If consumer feedback interaction is required, the application could present only the relevant choices pertaining to the task. The consumer could select an action based on buttons 25 on the flash memory card reader 2 or on the computer's keyboard or mouse click (not shown). The choices for selection could be presented as a flashing LED 26 adjacent to a labeled ‘function’ button 25, or a message on an LCD (not shown) screen or a pop-up menu on the USB equipped computer.

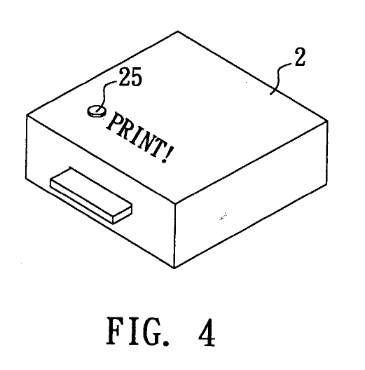

Referring to FIG. 4, which shows a simple reader which can trigger printing of images. Upon button 25 actuation being identified, a pre-determined task is launched, an example in FIG. 4 shows a reader 2 with single function button 25 which prints images from files in the memory card 5. The task would typically be an application to perform a complete task. For example archival of photographic image files would require copying of files from a flash memory card 5 into an organized structure of directories on a computer hard disk 13, and upon successful transfer the files on the memory card 5 would be deleted so that the card 5 is ready for the next pictures to be taken.

The particular way the function works could be set up the first time, and thereafter work in an identical manner.

This example could be automated, so that upon insertion of the card 5 into the reader 2 the files are copied across and the card 2 is cleared—automatically.

### Widespread Applicability

The invention comprising a flash memory card reader 2 with consumer actuation recognition and application software, has wide application, in office, SOHO and personal use.

It should be understood that one skilled in the art can make a number of variations in the hardware and system software elements within the scope of this invention without departing from the spirit thereof. Accordingly, this invention should be defined by the scope of the claims as broadly as the prior art will permit.

While the invention has been described with reference to a preferred embodiment thereof, it is to be understood that modifications or variations may be easily made without departing from the spirit of this invention, which is defined by the appended claims.

What is claimed is:

1. A flash memory card reader that is connected to a host computer which is equipped with at least one USB port, comprising:
a micro-controller for executing firmware instructions;
a connection means for connection to a flash memory card;
a USB interface circuit for connection to the at least one USB port of the host computer; and
at least one button for selection an action.

2. The flash memory card reader according to claim 1, wherein said flash memory card comprises at least one off a Compact Flash Memory card, a Smart Media card, a Memory Stick, a Multi Media card, a Secure Digital card, a IBM Microdrive, or a PC Card (PCMCIA).

3. The flash memory card reader according to claim 2, further comprising some application software installed on the computer which acts upon data stored in the flash card.

4. The flash memory card reader according to claim 3, wherein said application software detects consumer actuation of the at least one button on the reader, and launches at least one computer process task.

5. The flash memory card reader according to claim 4, wherein said application software continually checks for the actuation of the at least one button by the consumer.

6. The flash memory card reader according to claim 4, wherein said application software detects the insertion of memory card into the reader.

7. The flash memory card reader according to claim 5, wherein said application software detects the at least one button actuation by means of a USB Mass Storage read request.

8. The flash memory card reader according to claim 2, wherein said application software resides in the reader.

9. The flash memory card reader according to claim 8, wherein said application software resides in a virtual CD ROM USB device of the reader and automatically executes at the command of the micro-controller by the use of the AutoPlay or AutoRun Windows facility.

10. The flash memory card reader according to claim 4, wherein said at least one computer process task comprising data archival, editing, printing, send by email, post to web, purchasing of services, encryption, decryption are launched, by a reader device, results in a much simplified consume.

11. A method for automatically configuring under the control of a flash memory card reader, comprising the following step:
providing a control means for executing firmware instructions;
providing a connection means for connection to a flash memory card;
providing a interface means for connection to at least one USB port of a host computer; and
providing at least one button for selection an action;
while an consumer selecting one of the at least one button on the reader, said reader will detect consumer actuation and launch at least one computer process task to said host computer.

12. The method according to claim 11, wherein said flash memory card comprises at least one off a Compact Flash Memory card, a Smart Media card, a Memory Stick, a Multi Media card, a Secure Digital card, a IBM Microdrive, or a PC Card (PCMCIA).

13. The method according to claim 12, further comprising some application software installed on the host computer which acts upon data stored in the flash cards.

14. The method according to claim 13, wherein said application software continually checks for the actuation of the at least one button by the consumer.

15. The method according to claim 13, wherein said application software detects the insertion of memory card into the reader.

16. The method according to claim 13, wherein said application software detects the at least one button actuation by means of a USB Mass Storage read request.

17. The method according to claim 13, wherein said application software resides in the reader.

18. The method according to claim 11, wherein said at least one computer process task comprising data archival, editing, printing, send by email, post to web, purchasing of services, encryption, decryption are launched, by a reader device, results in a much simplified consume.

19. The method according to claim 13, wherein said consumer can configure said computer application process actions.
